(19) United States
(12) Patent Application Publication
(10) Pub. No.: US 2024/0088729 A1
(43) Pub. Date: Mar. 14, 2024

(54) ELECTRIC MACHINE FOR AN AIRCRAFT

(71) Applicant: Rolls-Royce Deutschland Ltd & Co KG, Blankenfelde-Mahlow (DE)

(72) Inventors: Anton RUDENKO, Unterhaching (DE); Johannes Gabriel BAUER, Eching (DE)

(21) Appl. No.: 18/210,210

(22) Filed: Jun. 15, 2023

(30) Foreign Application Priority Data
Jun. 15, 2022 (DE) 10 2022 115 127.1

(51) Int. Cl. H02K 1/04; C09D 5/00; C09D 127/18; H02K 21/24

(52) U.S. Cl. CPC H02K 1/04; B64D 27/30; C09D 5/00; C09D 127/18; H02K 21/24; H02K 2201/03

(57) ABSTRACT

An electric machine, (e.g., for an aircraft), includes a stator and a rotor that is rotatable relative to the stator, wherein a gap by way of which magnetic forces act between the stator and the rotor is configured between a gap face of the stator and a gap face of the rotor. The electric machine further includes a bearing installation by which the rotor is mounted so as to be rotatable relative to the stator in such a manner that the gap face of the rotor in a normal operation of the electric machine is spaced apart from the gap face of the stator. The stator and/or the rotor have/has a friction-reducing layer that at least partially forms the respective gap face and, along which the respective other gap face, is configured to slide in the event of a defect.

The present patent document claims the benefit of German Patent Application No. 10 2022 115 127.1, filed Jun. 15, 2022, which is hereby incorporated by reference in its entirety.

### TECHNICAL FIELD

The present disclosure relates in particular to an electric machine for an aircraft, and to an aircraft having such an electric machine.

### BACKGROUND

Aircraft are propelled in various design embodiments. Internal combustion engines, (e.g., piston engines or gas turbine engines), enable long ranges and high speeds. Drives with one electric motor or a plurality of electric motors make possible the use of sustainably produced energy and at times require low maintenance while being silent.

In the aerospace sector, it is desirable that the highest possible level of safety is guaranteed. A failure of a component should ideally be improbable. However, should a failure nevertheless occur, the consequences of the failure should ideally be kept at a minimum. A low overall weight may be pursued at the same time.

### SUMMARY AND DESCRIPTION

It is an object of the present disclosure to provide a safe electric machine.

The scope of the present disclosure is defined solely by the appended claims and is not affected to any degree by the statements within this summary. The present embodiments may obviate one or more of the drawbacks or limitations in the related art.

According to one aspect, an electric machine is disclosed, in particular for an aircraft. The electric machine includes a stator and a rotor that is rotatable relative to the stator. A gap by way of which magnetic forces act between the stator and the rotor is configured between a gap face of the stator and a gap face of the rotor. The electric machine further includes a bearing installation by which the rotor is mounted so as to be rotatable relative to the stator in such a manner that the gap face of the rotor in the normal operation of the electric machine is spaced apart from the gap face of the stator. It is provided here that the stator, the rotor, or the stator and the rotor, has/have a friction-reducing layer which (completely or at least partially) forms the respective gap face and along which the respective other gap face may slide in the event of a defect.

It is made possible as a result that the rotor may continue to rotate smoothly even in the event of a defect. In turn, this has the effect that various consequential damage may be avoided. This is because further parts of the electric machine could be destroyed by heavy friction. In many cases, the latter might be of secondary importance because the electric machine has been rendered defective and would have to be replaced anyway as a result of the defect that triggered the event. However, it has been demonstrated that the consequential damage mentioned may at times cause an abrupt stoppage of the rotor, which may occur so suddenly that a propeller or the like coupled to the rotor is shorn off, for example. In the case of an aircraft, a shorn-off propeller may represent a potential risk to passengers of the aircraft and on the ground. A particularly safe electric machine for an aircraft may thus be provided by the solution described above.

Events leading to defects are considered to be, for example, a delamination of a magnet retention bracket or of magnets, damage to bearings, a defective shaft or other structural defects, or else exceptionally strong gusts of wind or excessively hard impacts on landing may in principle lead to a defect. The solution described moreover permits improved tolerance in terms of specific defects. While commercially available machines may already suffer irreparable damage due to exceptionally strong gusts of wind or excessively hard impacts on landing, the solution described allows that some of these events leading to a defect may be sustained without damage. Overpressure in a cooling system, (e.g., of the stator), may also be considered an event leading to a defect. Bulging in the stator may arise as a result. An event leading to a defect may also be defined for example in that contact between the gap faces occurs.

The gap may filled with a gas or a gas mixture, (e.g., with air). The gap is in particular not provided with a lubricant. The two gap faces do not contact one another. Rotation of the rotor with particularly low friction is made possible in this way.

The friction-reducing layer is configured in the form of a coating or film, for example. In the event of a defect, this permits the friction to be reduced with a relatively low investment in terms of weight. The friction-reducing layer may be fastened to an underlying layer. The friction-reducing layer is optionally stretched over the underlying layer and/or adhesively bonded thereto.

The friction-reducing layer has, for example, a melting point of at least 200° C. or at least 300° C. In this way, the friction-reducing layer may withstand operation over a long period of time in the event of a defect.

Furthermore, the friction-reducing layer may include a plastics material, in particular a thermoplastic material. This permits a solution which is easy to produce and at the same time is lightweight.

The friction-reducing layer conjointly with the material of the respective other gap face in terms of dynamic friction has for example a coefficient of friction of 0.1 or less, 0.05 or less, or 0.04 or less. This permits particularly smooth running, even in the event of a defect.

The friction-reducing layer conjointly with the material of the other gap face has in particular a coefficient of friction that is lower than that of a material covered by the friction-reducing layer conjointly with the material of the other gap face.

In a specific example, the friction-reducing layer includes polytetrafluoroethylene (PTFE). This material has a high melting point, is robust, and at the same time enables particularly low friction.

The electric machine may be configured as an external rotor or as an axial flow machine. It may thus be provided, for example, that the rotor externally surrounds the stator. Alternatively, it may be provided that the rotor is disposed axially next to the stator. External rotors and axial flow machines in this instance have a significant advantage in comparison to internal rotors. While the centrifugal forces in the case of internal rotors have the effect of narrowing the gap between the gap faces, the centrifugal forces do not have any significant effect on the gap in the case of axial flow machines. In the case of external rotors, the centrifugal forces indeed have the effect of widening the gap between the gap faces. The mounting of the rotor in the case of internal rotors is indeed simpler and may be more precise in comparison to external rotors and axial flow machines. In the present solution, however, this may be compensated by the greater tolerance in relation to specific events leading to a defect, such as in relation to transverse forces in the event of an excessively hard impact on landing. Because the frictional force is a function of the normal force and the coefficient of friction, in the case of an external rotor the centrifugal force acts counter to the friction.

A reservoir that contains a lubricant is optionally disposed in the region of the gap. The lubricant is stored in the reservoir. The reservoir is closed off. Sliding of the opposite gap face along the reservoir in the event of a defect leads to a force acting on (optionally destroying) the reservoir (e.g., a casing or the like) and consequently to the lubricant formerly contained in the reservoir being released into the gap. Because there is a gap between the gap faces during normal operation, the lubricant is not required. However, the lubricant may cause an additional reduction in terms of friction in the event of a defect leading to contact between the gap faces. This particular embodiment advantageously permits a tailored solution for this purpose.

The reservoir may include a sponge material in which the lubricant is received. This permits the lubricant to be successively dispensed according to the requirement in the event of a defect.

The reservoir is fixed to the stator, for example, in particular disposed so as to be adjacent to a coil of the stator (in particular above the coil). In this way, the reservoir may store the lubricant without damage over a long period up to an event leading to a defect.

A multiplicity of reservoirs is optionally provided. This enables the lubricant to be dispensed in a spatially distributed manner in the event of a defect.

The lubricant is present, for example, in the form of a grease, for example, as a cold grease. This enables simplified storage and the prevention of unintentional discharge.

The electric machine may be configured in the form of an electric motor. For example, the electric machine has a shaft that is in particular specified for driving a rotor unit having rotor blades. In this way, a drive system having the electric machine and including the shaft and the rotor unit may be achieved.

According to one aspect, an aircraft is provided, wherein the aircraft includes a rotor unit having rotor blades and the electric machine according to an arbitrary design embodiment described herein for driving the rotor unit. The rotor unit and the electric machine form a drive system for the aircraft. The drive system serves for generating thrust and/or lift for the aircraft.

### BRIEF DESCRIPTION OF THE DRAWINGS

Exemplary embodiments will now be described by way of example with reference to the figures with schematic illustrations in which:

FIG. 1 depicts an embodiment of an aircraft in the form of an airplane having an electrically driven rotor unit;

FIG. 2 depicts an embodiment of an electric machine of the aircraft according to FIG. 1 in the form of an external rotor;

FIG. 3 depicts an embodiment of an electric machine for the aircraft according to FIG. 1 in the form of an axial machine;

FIG. 4 depicts an embodiment of a portion of a stator and of a rotor of the electric machine according to FIG. 2, and for the electric machine according to FIG. 3;

FIG. 5 depicts an alternative embodiment of the stator and of the rotor for the electric machine according to FIG. 2, and for the electric machine according to FIG. 3;

FIG. 6 depicts a further alternative embodiment of the stator and of the rotor for the electric machine according to FIG. 2, and for the electric machine according to FIG. 3; and

FIG. 7 depicts a further alternative embodiment of the stator and of the rotor for the electric machine according to FIG. 2, and for the electric machine according to FIG. 3.

### DETAILED DESCRIPTION

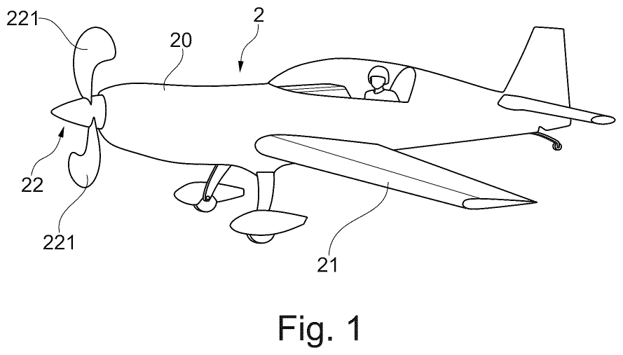

FIG. 1 shows an aircraft 2 in the form of an electrically driven airplane having a fuselage 20 and wings 21.

The aircraft 2 includes a drive unit having a rotor unit 22 that is driven by an electric machine of the drive system. The rotor unit 22 includes a plurality of rotor blades 221, here in an exemplary manner two rotor blades 221. The rotor blades 221 in the example shown are assembled on a hub and thus form a propeller. In alternative design embodiments, the aircraft 2 includes, for example, a fan instead of a propeller and/or a plurality of drive systems each having at least a propeller, a fan, or the like.

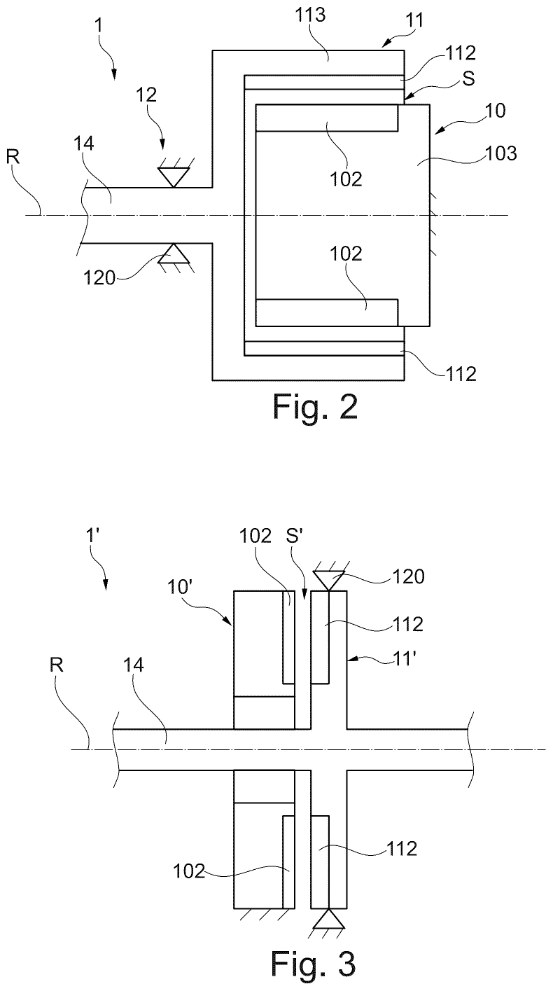

FIG. 2 shows the electric machine 1 of the aircraft 2. The electric machine 1 is configured in the form of an electric motor (which may optionally also be used as a generator) and includes a stator 10, a rotor 11, a bearing installation 12, and a shaft 14.

The rotor 11 by the bearing installation 12 is mounted so as to be rotatable about a rotation axis R relative to the stator 10. The electric machine 1 is presently configured as an external rotor, the rotor 11 thus surrounding the stator 10. The stator 10 is at least in portions received in the rotor 11. The stator 10 is fixedly assembled on a support of the aircraft 2. For example, the stator is fixed relative to the fuselage 20.

The bearing installation 12 includes a plurality of bearings 120 of which one in the form of a ball bearing 120 is visualized here only by way of example.

The stator 10 includes a body 103 on which a plurality of electric coils 120 are fixedly established. The rotor 11 includes a body 113 on which a plurality of magnets 112 in the form of permanent magnets are fixedly established. Permanently excited electric machines permit particularly high-power densities and torque densities.

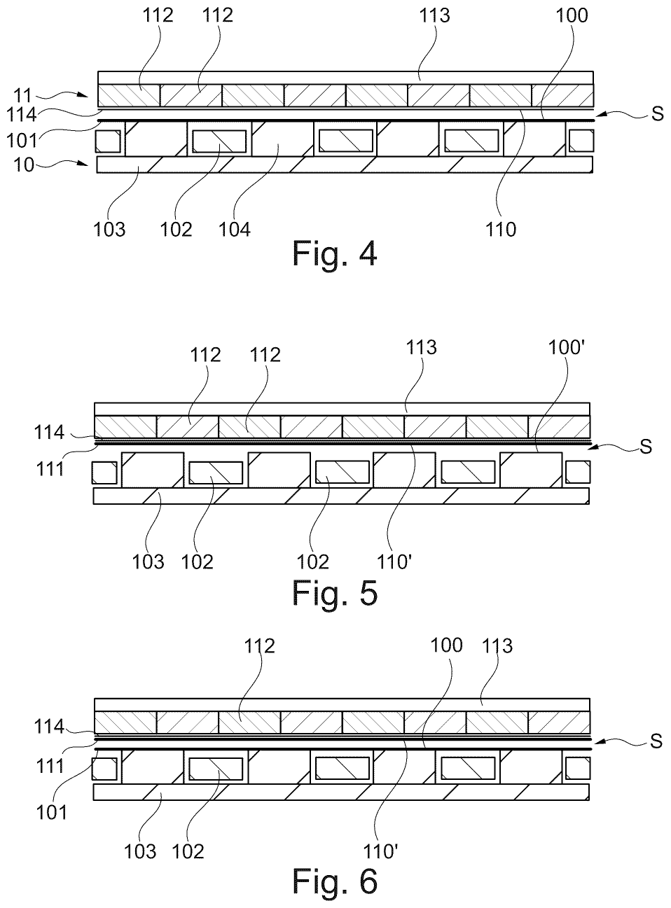

An electric current running through the coils 102 generates a magnetic field that sets the rotor 11 in rotation about the rotation axis R. A gap S by way of which the magnetic forces act between the stator 10 and the rotor 11 is configured between the stator 10 and the rotor 11 here. The gap S may be filled with a gas or a gas mixture, e.g., with air. The gap S has a circular-cylindrical shape. In this way, the rotor 11 and the stator 10 are mutually separated by an air gap of hollow-cylindrical shape. The gap S is externally delimited by a gap face 110 of the rotor 11 (cf. FIG. 4, for example). The gap S is internally delimited by a gap face 100 of the stator 10. Each gap face 100, 110 (at least substantially) defines a circular-cylindrical shape. The inner gap face 100 is smaller than the outer gap face 110. The two gap faces 100, 110 are aligned so as to be mutually coaxial (and coaxial with the rotation axis R). The gap faces 100, 110 are mutually spaced apart at each point. The gap faces 100, 110 thus do not contact one another during normal operation. The rotor 11 by the bearing installation 12 is mounted so as to be rotatable relative to the stator 10 in such a manner that the gap face 110 of the rotor 11 in the normal operation of the electric machine 1 is spaced apart from the gap face 100 of the stator 10.

An elastic or plastic deformation of one or a plurality of components of the electric machine 1 may arise in the event of a defect. Furthermore, an at least partial delamination of magnets 112 and/or coils 102 or of other components may arise. This may be caused, for example, by damage to the bearing installation 12, to the shaft 14, or to any other part. Furthermore, a heavy gust of wind beyond the design limits or a hard impact on landing beyond the design limits may cause such an event leading to a defect.

For this purpose, the stator 10 and/or the rotor 11 has/have a friction-reducing layer 101, 111 that is explained in more detail hereunder, in particular in the context of FIG. 4, and defines the respective gap face 100, 110 of the rotor 11 and/or of the stator 10 (presently the complete respective gap face 100, 110, or alternatively at least part of the respective gap face 100, 110) and along which the respective other gap face 100, 110 may slide with low friction in the event of a defect.

FIG. 3 shows an electric machine 1′ for the aircraft 2, wherein the aircraft 2 may include instead of the electric machine 1 according to FIG. 2 or in addition thereto.

The electric machine 1′ includes a stator 10′, a rotor 11′ that is rotatable relative to the stator 10′. A gap S′ by way of which magnetic forces act between the stator 10′ and the rotor 11′ is configured between a gap face (cf. FIG. 4, for example) of the stator 10′ and a gap face of the rotor 11′. The electric machine 1′ further includes a bearing installation by which the rotor 11′ is mounted so as to be rotatable relative to the stator 10′ in such a manner that the gap face of the rotor 11′ in the normal operation of the electric machine 1′ is spaced apart from the gap face of the stator 10′. The stator 10′ and/or the rotor 11′ here have/has a friction-reducing layer (cf. FIG. 4, for example) that forms the respective gap face and along which the respective other gap face may slide in the event of a defect.

The electric machine 1′ is an axial force machine, i.e., the magnetic fields bridge the gap S′ in the axial direction. The stator 10′ and the rotor 11′ thus have in each case circular disc-shaped gap faces. The gap S′ likewise has the shape of a circular disc. The gap faces of the rotor 11′ and of the stator 10′ are mutually spaced apart in the axial direction, parallel to the rotation axis R.

The drive system optionally includes a plurality of electric machines 1′ on the shaft 14. If one electric machine 1′ fails, the latter may continue to run passively as a result of the reduction in friction described herein, and the drive system may continue to operate. Furthermore, the electric machine 1, 1′ according to FIG. 2 or according to FIG. 3 may be operated with an internal combustion engine (for example, a gas turbine), in particular on the same shaft 14, in a hybrid electric drive. In the event of a failure of the electric machine 1, 1′, the internal combustion engine may in any case continue to operate during a limited period of time. Additional clutches may be dispensed with in these cases, which may significantly reduce the overall weight.

FIG. 4 by way of example shows a portion of the stator 10 and of the rotor 11 having the intervening gap S. The curvature of the assembly is not shown, merely for reasons of a simplified illustration.

The magnets 112 are fastened in pairs with alternating polarities on the body 113 of the rotor 11. The magnets are covered by a retention layer 114 for securing the magnets 112 on the body 113. The retention layer 114 extends across the magnets 112. The retention layer 114 has a surface which faces the stator 10 and represents the gap face 110 of the rotor 11.

The coils 102 of the stator 10 are wound about stator teeth 104 configured on or fastened to the body 103. The stator teeth 104 and the coils 102 are covered by a friction-reducing layer 101. The friction-reducing layer 101 forms the gap face 100 of the stator 10. The illustration of the stator teeth 104 and of the coils 102 is merely exemplary. The stator teeth 104 may in particular have portions which extend across the coils 102 so as to secure the coils.

The gap S is configured between the retention layer 114 and the friction-reducing layer 101.

The friction-reducing layer 101 is configured in the form of a film, alternatively in the form of a coating. The friction-reducing layer is composed of PTFE and thus has a melting point of at least 300° C. Furthermore, the friction-reducing layer 101 conjointly with the material of the retention layer 114 has a coefficient of friction of 0.04. The retention layer 114 is composed of a composite material, for example. The retention layer optionally includes carbon fibers. For example, this is a carbon fiber-reinforced composite material, with epoxy resin as the matrix material, for example.

Those regions of the stator teeth 104 that are covered by the friction-reducing layer 101 include, for example, electric sheets, or are composed thereof, respectively. The friction-reducing layer 101 conjointly with the material of the other gap face 110 (e.g., the retention layer 114) thus has a coefficient of friction that is lower than that of a material covered by the friction-reducing layer 101 conjointly with the material of the other gap face 110. In the event of a defect, the friction-reducing layer 101 comes into contact with the retention layer 114 and slides along the latter (e.g., with little friction).

In the event of a defect, the solution described permits dry running of the electric machine 1 that may prevent consequential damage and potentially even prevent damage completely.

FIG. 5 visualizes that a friction-reducing layer 111 may be provided on the rotor 11 instead of on the stator 10. In this case, the friction-reducing layer 111 thus covers the retention layer 114. In this way, the friction-reducing layer 111 forms the gap face 110′ of the rotor 11, while the stator teeth 104 forms the gap face 100′ of the stator 10.

In the event of a defect, the friction-reducing layer 111 thus comes into contact with the stator teeth 104 and slides along the latter (e.g., with little friction).

The friction-reducing layer 111 optionally also serves as a retention layer so that the additional retention layer 114 may be dispensed with. In this instance, the friction-reducing layer 111 bears directly on the magnets 112.

FIG. 6 visualizes that a friction-reducing layer 111 on the rotor 11 may be provided in addition to a friction-reducing layer 101 on the stator 10. In this case, the friction-reducing layer 111 of the rotor 11 thus covers the retention layer 114, while the friction-reducing layer 101 of the stator 10 covers the stator teeth 104.

In this way, the friction-reducing layer 111 of the rotor 11 forms the gap face 110′ of the rotor 11, and the friction-reducing layer 101 of the stator 10 forms the gap face 100 of the stator.

In the event of a defect, the friction-reducing layer 111 of the rotor 11 thus comes into contact with the friction-reducing layer 101 of the stator 10 and slides along the latter (with particularly little friction).

Depending on a predefined frictional output, a selection may be made from the variants of FIGS. 4 to 6. For example, the variant of FIG. 6 is particularly suitable for high-speed motors.

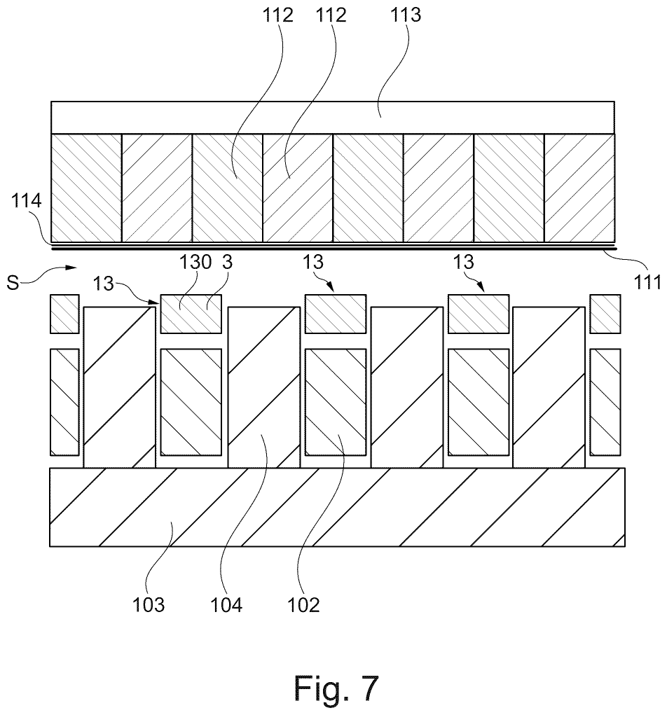

FIG. 7 visualizes optional reservoirs 13 for lubricants 3. The reservoirs 13 are disposed in the region of the gap S and presently project from adjacent regions of the stator 10 into the gap S. In the event of a defect, the rotor 11 (presently the friction-reducing layer 111 of the rotor 11) slides along the reservoirs 13 and acts on the latter (for example, shears off the projecting portions, opens the latter, or compresses the latter) so that the lubricant 3 contained therein is released into the gap S. Friction is even further reduced as a result.

The lubricant 3 may be a grease, e.g., a cold grease.

In the example shown, the reservoirs 13 bear on the coils 102. Each reservoir 13 is disposed between two stator teeth 104. The reservoirs 13 cover the coils 102.

In order for the lubricant 3 to be dispensed according to the requirement and to be securely stored, each reservoir includes a sponge 130. The sponge 130 is fully soaked with the lubricant 3 and releases the lubricant 3 under the influence of force.

Alternatively, the stator 10 on the gap face thereof may be permanently covered by lubricant, or lubricant is injected into the gap S by a control system when an event leading to a defect is identified. It is furthermore conceivable that a material which dispenses lubricant as a consequence of an elevated temperature is used.

In the event of a defect leading to damage, the reduced friction permits the rotor 11, 11′ to be decelerated in a controlled manner, as a result of which more serious consequential damage may be prevented.

Alternatively, or additionally, to the variants described, the friction-reducing layer 101 may be provided by slot closure wedges (made from a corresponding material) (each with or without being oversized into the air gap). Each slot closure wedge may be disposed between two stator teeth 104 of the stator 10, 10′. This would look like the assembly shown in FIG. 7, for example, however having slot closure wedges instead of the reservoirs 13 and with or without the friction-reducing layer 111 on the rotor 11.

### LIST OF REFERENCE SIGNS

1; 1′ Electric machine
10, 10′ Stator
100; 100′ Gap face
101 Friction-reducing layer
102 Coil
103 Body
104 Stator tooth
11; 11′ Rotor
110; 110′ Gap face
111 Friction-reducing layer
112 Magnet
113 Body
114 Retention layer
12 Bearing installation
120 Bearing
13 Reservoir
130 Sponge
14 Shaft
2 Aircraft
20 Fuselage
21 Wing
22 Rotor unit
221 Rotor blade
3 Lubricant
R Rotation axis
S; S′ Gap

1. An electric machine comprising:
a stator;
a rotor that is rotatable relative to the stator;
a gap by way of which magnetic forces act between the stator and the rotor that is positioned between a gap face of the stator and a gap face of the rotor; and
a bearing installation by which the rotor is mounted so as to be rotatable relative to the stator in such a manner that the gap face of the rotor in a normal operation of the electric machine is spaced apart from the gap face of the stator,
wherein at least one of the stator or the rotor comprises a friction-reducing layer that at least partially forms the respective gap face and along which the respective other gap face is configured to slide in an event of a defect.

2. The electric machine of claim 1, wherein the gap is filled with a gas or a gas mixture.

3. The electric machine of claim 2, wherein the gas or the gas mixture comprises air.

4. The electric machine of claim 1, wherein the friction-reducing layer is in a form of a coating or a film.

5. The electric machine of claim 1, wherein the friction-reducing layer has a melting point of at least 200° C.

6. The electric machine of claim 1, wherein the friction-reducing layer has a melting point of at least 300° C.

7. The electric machine of claim 1, wherein the friction-reducing layer comprises a plastic material.

8. The electric machine of claim 6, wherein the plastic material is a thermoplastic material.

9. The electric machine of claim 1, wherein the friction-reducing layer conjointly with a material of the other gap face has a coefficient of friction of 0.1 or less.

10. The electric machine of claim 1, wherein the friction-reducing layer conjointly with a material of the other gap face has a coefficient of friction that is less than that of a material covered by the friction-reducing layer conjointly with the material of the other gap face.

11. The electric machine of claim 1, wherein the friction-reducing layer comprises polytetrafluoroethylene.

12. The electric machine of claim 1, wherein the electric machine is configured as an external rotor or as an axial flow machine, and
wherein the rotor correspondingly externally surrounds the stator or is disposed axially next to the stator.

13. The electric machine of claim 1, further comprising:
a reservoir containing a lubricant,
wherein the reservoir is disposed in a region of the gap, and
wherein the lubricant is configured to be released from the reservoir into the gap by the gap face of the stator or the gap face of the rotor sliding along the reservoir in the event of the defect.

14. The electric machine of claim 13, wherein the reservoir comprises a sponge in which the lubricant is received.

15. The electric machine of claim 13, wherein the reservoir is disposed on the stator so as to be adjacent to a coil of the stator.

16. The electric machine of claim 13, wherein the reservoir comprises a multiplicity of reservoirs.

17. The electric machine of claim 13, wherein the lubricant is a grease.

18. The electric machine of claim 1, wherein the electric machine is an electric motor having a shaft configured to drive a rotor unit comprising rotor blades.

19. The electric machine of claim 1, wherein the electric machine is a component of an aircraft.

20. An aircraft comprising:
a rotor unit comprising rotor blades; and
an electric machine configured to drive the rotor unit, wherein the electrical machine comprises:
a stator;
a rotor that is rotatable relative to the stator;
a gap by way of which magnetic forces act between the stator and the rotor that is positioned between a gap face of the stator and a gap face of the rotor; and
a bearing installation by which the rotor is mounted so as to be rotatable relative to the stator in such a manner that the gap face of the rotor in a normal operation of the electric machine is spaced apart from the gap face of the stator,
wherein at least one of the stator or the rotor comprises a friction-reducing layer that at least partially forms the respective gap face and along which the respective other gap face is configured to slide in an event of a defect.
